(19) United States
(12) Patent Application Publication
(10) Pub. No.: US 2020/0383274 A1
(43) Pub. Date: Dec. 10, 2020

(54) Supporting Wire Structure for Floral Arrangements

(71) Applicant: J C. Thomasson, Florissant, MO (US)

(72) Inventor: J C. Thomasson, Florissant, MO (US)

(21) Appl. No.: 16/873,744

(22) Filed: Jun. 22, 2020

Related U.S. Application Data
(63) Continuation-in-part of application No. 29/651,670, filed on Jun. 10, 2019, now Pat. No. D888607.

(51) Int. Cl. A01G 5/02; A47G 7/02

(52) U.S. Cl. CPC A01G 5/02; A47G 7/02

(57) ABSTRACT

A support wire base for floral arrangements which may be applied onto a table, furnish a wall decor, suspended, for showing such arrangement of flowers during usage. The support includes a core, which has a plurality and multitude of wires extending radially or tangentially from the core, the wires may be of the same length or of varying lengths, and provided for holding a series of flowers and their short stems, leaves, or other greenery, or even other decorative devices, in the floral arrangement, during its usage, application, and display.

### CROSS REFERENCE TO RELATED APPLICATION

This invention and patent application is a continuation-in-part of the design patent application of the same inventor, having Ser. No. 29/651,670, filed on Jun. 10, 2019, in the United States Patent Office.

### FIELD OF THE INVENTION

This invention relates to an independent wire self-supporting structure designed for usage in supporting and holding floral arrangements, for display at the home, business, or at events.

### BACKGROUND OF THE INVENTION

This invention relates to a floral design in a more contemporary application, with a basic structure formulated from an assembly of various wires, along a central structural core, that enables the essence of the floral design to be added and support the addition of flowers and greenery, in a variety of ways, with the wires holding the flowers along the length of the center core and support, during its usage and application.

There are a variety of floral type arrangements, and holders for accommodating such, in the prior art. For example, the published application to Stevenson, No. US 2014/0370467, shows an artificial floral arrangement and method for therapy. U.S. Pat. No. 6,099,921, to Schmidt, et al, shows a further formable decorative greenery. The greenery is just applied to an elongate formable member. The patent to Brenner, U.S. Pat. No. 2,258,442, shows a corrugated wire ring for floral wreaths. The patent to Royalty, U.S. Pat. No. 5,207,758, shows a method of manufacturing a wreath, apparently using a spiral or helical coil. And, the patent to Nichols, U.S. Pat. No. Des. 271,675, shows a floral arrangement base.

Another group of parents show various types of holders for floral arrangements, of their own specific design, and structure. For example, the patent to Mayer, U.S. Pat. No. Des. 249,660, shows a holder for floral arrangement. The patent to Crescenti, U.S. Pat. No. 4,1717,790, shows a further structured floral support. The patent to Koistinen, U.S. Pat. No. 4,418,496, shows a further support structure for a small floral arrangement. Other related patents are U.S. Pat. Nos. 4,6060,950; Des. 297,823; 5,682,722; 5,683,762; . 5,697,185; 6,457,276; published application No. US2005/0011116; published application No. US2011/0049309; U.S. Pat. Nos. 8,069,609; 5,171,615; 3,834,976; and Des. 180,980.

There are other unrelated structures that may have similar appearance to the current invention but are used in an entirely different settings and for discrete applications. For example, patent No. U.S. Pat. No. D625,471, shows a fish retention structure. U.S. Pat. No. 9,992,988, shows a further fish attracting assembly. Published application No. US2018/0199564, shows a cooling panel assembly. U.S. Pat. No. D588,495, shows a merchandise hanger assembly. Published application No. US2012/0260444, shows a bristle-pad hairbrush. Published application No. US2006/0225760, shows a flocked wire mascara brush. Published application No. US2019/0379196, shows a power line protective apparatus. Other patents showing somewhat unrelated structures can be seen design U.S. Pat. Nos. Des. 424,470; D787,365; published application No. US2015/0071695; U.S. Pat. Nos. D607,081; D607,082; 9,743,593; 9,736,992; 8,650,779; D689,793; 5,996,190; 5,453,308; 5,279,072; 5,158,355; and 4,282,683.

Another field of usage of various wires, and primarily for application in functioning as bird repellents, can be seen in published application No. US2018/0368390; published application No. US2005/0160685; published application No. US2014/0041318; U.S. Pat. Nos. 7,802,405; D6923,899; D828,484; D. 404,107; published application No. US2004/0040325; published application No. US2003/0208967; U.S. Pat. No. 7,596,910; and published application No. US2004/0216393.

These are the abundance of prior art structures that are related to the current invention or have structures of similar appearance but are for totally unrelated applications.

### SUMMARY OF THE INVENTION

This invention relates to a support wire base for floral arrangements, as for use on the table or decor, wall decor, bouquets, and atop other containers. The floral arrangement apparatus may be manipulated in a variety of ways, and is formed of a central core or long center support, with groupings of wires provided around the structure of the core, either secured thereto by welding, wrapping around the core, or by other means of attachment, even by adhesive, wherein the wires are provided extending generally radially from the core, at least along three of it sides, and upon which floral arrangements may be applied, along the length of the core or support, to enhance the attractiveness of the floral arrangement, when installed and employed. The various wires may be of uniform length, or may include a series of lengthier wires, shorter wires, radially applied to the core, for use for holding a variety of flowers, and other plant material, in position to provide an enhanced display from the floral arrangement.

The wire utilized may be approximately an 18-gauge wire, although gauges of different dimensions, more or less than 18 gauge, may be employed. The wires that extend radially from the central core extend in all angles, particularly when the floral arrangement may be vertically employed, or the wires may extend from the central core in a variety of directions, except from the bottom of the core, particularly when it is to be horizontally supported upon a table or other base, when displaying its floral arrangement. The lighter gauge wires, less than the 18 gauge, may be more easily manipulated, when it is desired to wrap the wire around the flower and its shortened stem, particularly at the ends of the arrangement, in order to hold them in position. Likewise, as can be understood, where heavier gauge wires may be used, the floral arrangements may be interwoven within the wires, to provide for full support along the length of the supporting wire structure, or the various flowers, or its stems, may be tied into position, or fastened to the wires, to provide for their full support. The center core may be of almost any solid like material, or even a tube of metal, or the like, in order to support the connection of the various and multitude of wires thereto, when forming the wire support, initially.

It is, therefore, the principal object of this invention to provide a supporting wire structure for functioning as means for holding floral arrangements in position for display.

Another object of this invention is to provide a supporting wire structure where the wires may be of different lengths, in order to provide different levels for the display of the various attached and held flowers and other decorations, upon the structural support, during its assembly, usage and application.

Another object of this invention is to provide a central core, which may be formed of any variety of materials, whether it be metal, wood, polymer, polymer foam structure, or the like, and may be solid or tubular, but having sufficient strength to hold a variety of radially secured wires to the core, in preparation for its usage and application.

Another object of this invention is to provide a structural support, formed of a variety of different lengths of wires, that may be used for holding floral arrangements, whether the arrangements be rested upon a base, or table, hung on a wall, or vertically suspended, during its usage and application.

A further object of this invention is to provide a supporting wire structure and floral arrangement that may be used in the home, in a business, at various banquet halls, as at wedding receptions or anniversaries, to the delight and pleasure of the attendees.

These and other objects may become more apparent to those skilled in the art upon review of the Summary of the Invention as provided herein, and upon undertaking a study of the Description of its Preferred Embodiments, in view of the drawings.

### BRIEF DESCRIPTION OF THE DRAWINGS

In referring to the drawings,

FIG. 1 is an isometric view of the support wire structure for floral arrangements of this invention;

FIG. 2 is a front view thereof;

FIG. 3 is a back view thereof;

FIG. 4 is a top view;

FIG. 5 is a bottom view;

FIG. 6 is a right-side view;

FIG. 7 is a left side view;

FIG. 8 is an isometric view of the supporting wire structure of this invention shown the floral arrangements applied thereto, the latter being disclosed in phantom lines;

FIG. 9a is an isometric view of a tubular core structure for forming the support wire structure for this invention;

FIG. 9b is a similar type of support wire structure where the core is formed arcuate;

FIG. 9c is the support for wire structure where the core structure is formed of a serpentine shape;

FIG. 9d is a support wire structure wherein the core is circularly formed for holding a variety of extending wires; and

FIG. 9e is an isometric view of the support wire structure where the core structure is formed of a moisture retaining polymer foam core.

### DESCRIPTION OF THE PREFERRED EMBODIMENT

As previously summarized, this invention relates to a support wire base for floral arrangements as for use on a table, for decor, wall decoration, bouquets, and atop other supporting structures, in usage. The device may be either horizontally disposed upon a table or other base or surface, or it can be hung onto the wall, once the floral arrangement has been introduced, or may be suspended vertically to display its floral concept. The floral arrangement apparatus may be manipulated in a variety of ways, as by bending or angling of their wires, to the desired shape. A thick center support, such as a core, as may be made of wood, metal, polymer, or foam, and which may or may not be in tube configuration, and the shape of the core may be round, square, or to other configurations. The core supports a variety of perpendicularly or radially arranged or tangentially extending wires, from the core, and these wires may be bent or angled, to desired shapes, in order to support the type of floral arrangements that are added to the wires, during its assembly. Obviously, the core, and the wires, may be flattened on one surface so it can rest horizontally on a support or table. The floral material may include flowers, greenery, other floral material, water tubes, and even other decorative elements, such as ribbons, that may be added to the floral arrangement.

In referring to FIG. 1, therein can be seen the supporting wire structure for floral arrangements 1 of this invention. It includes, as mentioned, its center core or support 2 that may extend approximately the length of the structure of the device, and can be seen, it includes that multitude or plurality of wires that generally are radially, perpendicularly, or tangentially extending from the core 2, such wires normally as can be seen at 3. The wires may be straight, as noted, or they may be bent to various configurations, in order to hold the type of floral arrangements and flowers that may be added to the same, during usage.

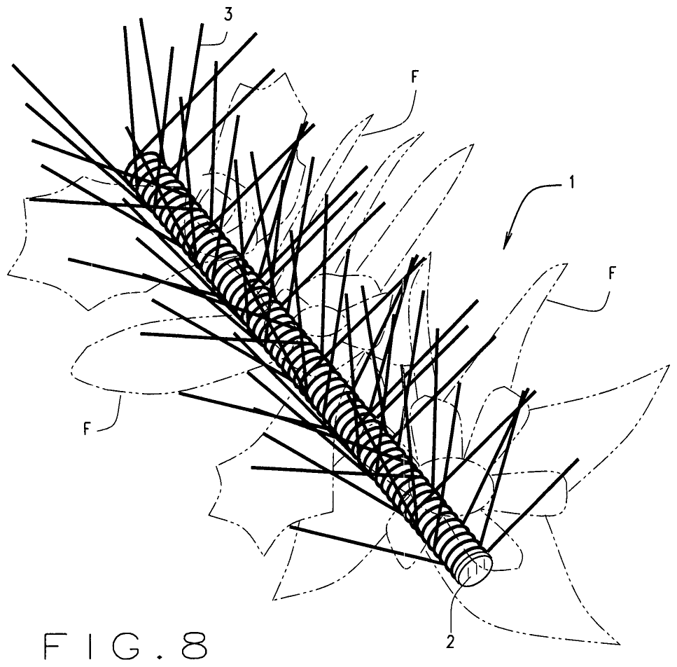

An example of the floral arrangement can be seen in FIG. 8, where the core 2 and its wires 3 of the structure 1 support the variety of floral arrangements, as noted at F, and which may be flowers, leaves, other types of greenery, that may be added to the floral arrangement, during its preparation.

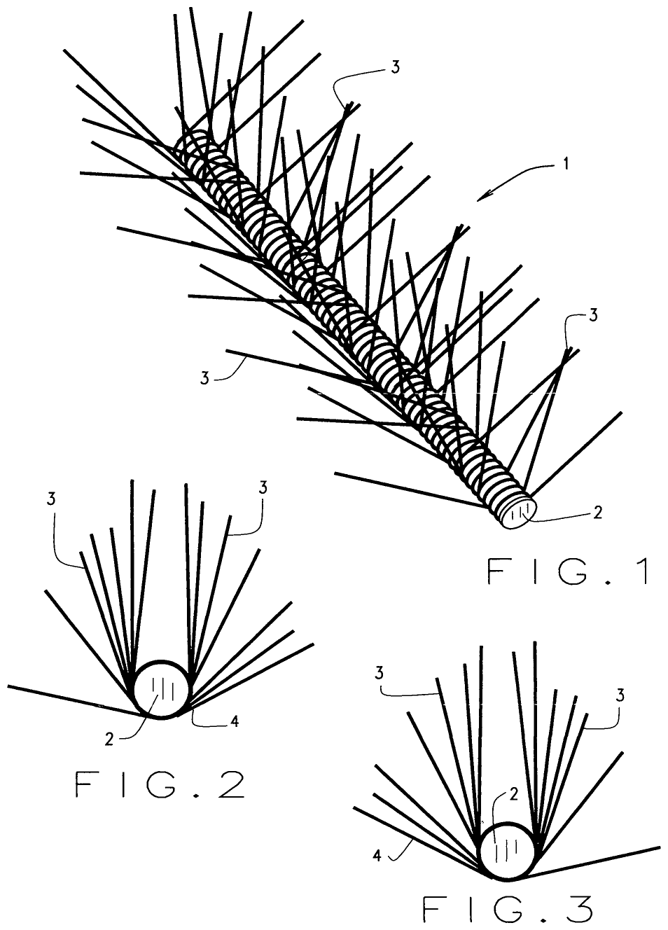

As can be seen in FIGS. 2 and 3, which are the two end views, the wires generally extend around the core 2, and, in this instance, are generally tangentially extending from the core, as noted at 4.

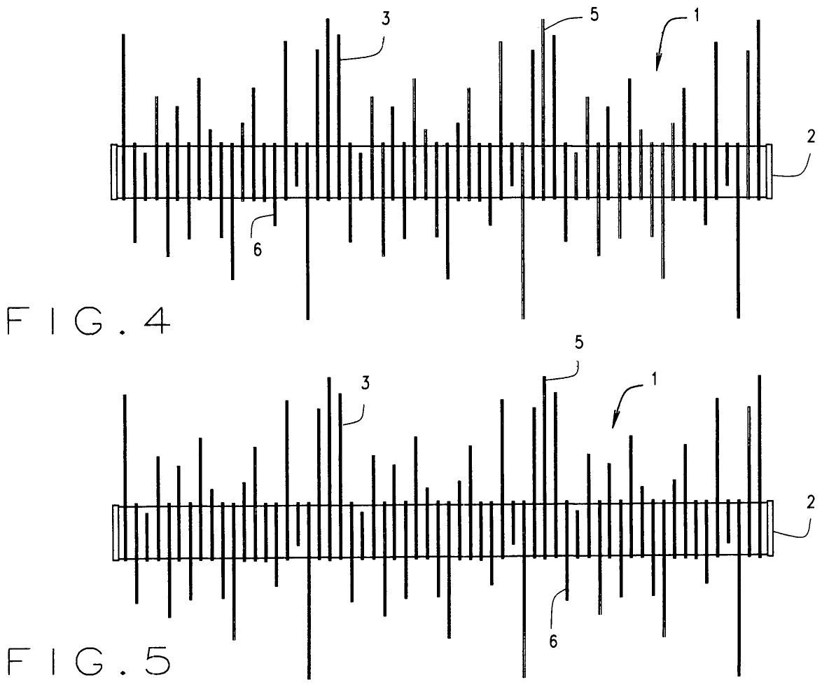

FIGS. 4 and 5 show, respectively, the top view, and bottom view, of the supporting wire structure 1. It might be stated that the core 2 may also be formed of a solid material, or may even include a water carrying tube, for more delicate flowers that may be applied to the structure, as can be understood. Furthermore, the wires 3 may be of differing lengths, having longer wires, as at 5, or may include shorter wires, as at 6, depending upon the desires of the assembler, when producing the floral arrangement.

The core structure may be formed of various materials, as stated, whether it be of wood, metal, polymer, may be of solid material, or formed as tubular material, and may have different cross-sectional shapes, such as round, square, rectangular, or even oval shapes. In addition, the core structure may be formed of a polymer foam, and be able to retain moisture, for adding to the useful life of the floral arrangement during its usage. Furthermore, the core structure may be formed of a longitudinal length, or be of a circular design, or be arcuate of configuration, or of a serpentine shape, to add to its unique floral display.

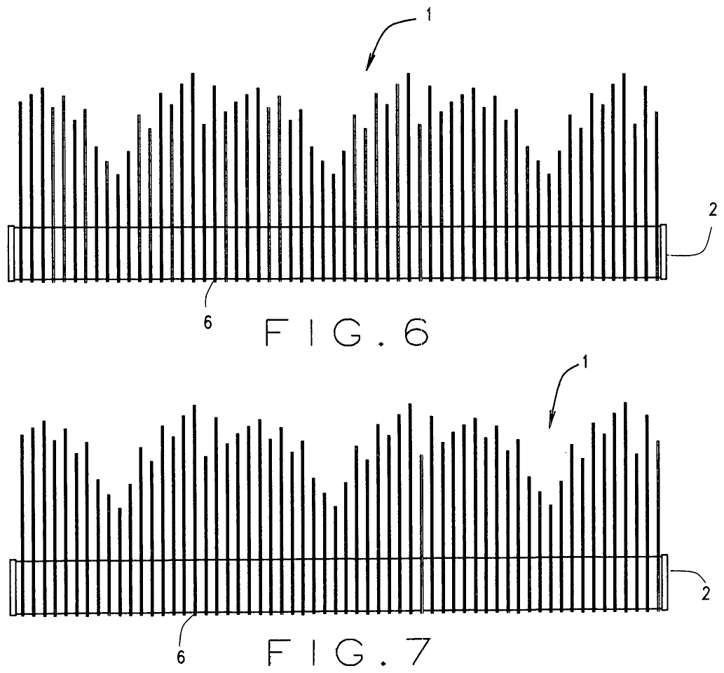

The length of the wires can also be seen in FIGS. 6 and 7, for the support wire structure 1, of this device. As stated, the wires may be longer wires, or shorter wires, or they may all be of the same length, but radiate from the core 2, in a variety of directions. The type of wire structure as shown in FIGS. 6 and 7, with its generally bottom 6 free of extending wires, as noted, may be the type that will rest upon a horizontal base or table, during its usage. Or, with a flattened bottom 6, such a floral arrangement, as supported herein, may be applied to the wall, in usage. Or, as previously explained, the wire structures, that may extend radially or tangentially from the core 2 in all directions, and may be hung vertically, during its usage. These are examples of the various uses that the supporting wire structure of this invention may be employed, assembled, when holding their floral arrangements, and how they are to be displayed, during application.

Furthermore, as stated, while the wires in the preferred embodiment may have an 18 gauge form of wire, such a gauge may be heavier, in order to accommodate a more permanent holding of the floral arrangement, or all or some of the wires, particularly at the ends of the core, may be of a lighter gauge, so the wires can be bent, perhaps for surrounding the stem of the supported flowers, to hold the same in position during application and usage of this device.

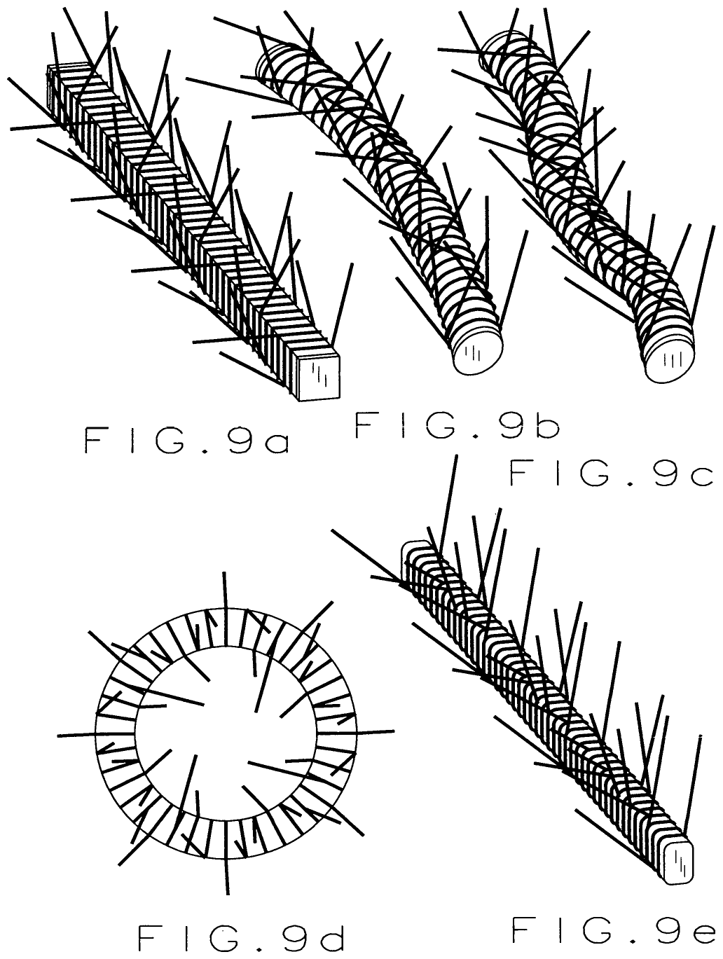

As can also be seen, FIGS. 9a-9e show various shaped structural cores that may be used in the formation of the supporting wire structure of this invention. For example, 9(a) shows that the core may be formed of a square or rectangular configuration, rather than the round as shown in FIG. 8. FIG. 9b shows how the structural core may be of arcuate form. FIG. 9c shows how the structural core may be of a serpentine or undulated form. FIG. 9d shows that the structural core may be of circular design. And, FIG. 9e discloses how the structural core may be formed of a polymer foam or polystyrene, and even hold some moisture, in order to maintain the freshness of the applied floral arrangement. These are examples of the various shapes and configurations that may be made of the supporting wire structure of this invention.

Variations or modifications to the subject matter of this invention may occur to those skilled in the art upon review of the disclosure as provided herein. Such variations, if within the spirit of this invention, are intended to be encompassed within the scope of any claims to patent protection issuing herein. The Summary of the Invention as set forth in the Specification, and as depicted in the drawings, are set forth for illustrative purposes only.

I claim:

1. A supporting wire structure for holding a floral arrangement, comprising:
a core structure, said core structure having a length, said core structure formed of metal, wood, polymer or foam; and
a series of wire lengths secured with and extending from said core structure, said wire lengths arranged extending in many directions from said core structure, and said wire lengths disposed for holding flowers, leaves, or other greenery for display as a floral arrangement.

2. The supporting wire structure of claim 1, wherein said core structure may be formed of solid or tubular material, and having cross-sectional shape of round, square, rectangular, or of oval configuration.

3. The supporting wire structure of claim 2, wherein said series of wire lengths extending radially or tangentially from the core structure, and said wire lengths being of either short, medium, or lengthy dimensions.

4. The supporting wire structure of claim 3, wherein said core structure is formed of one of a longitudinal straight length, arcuate, serpentine, or circular of design.

5. The supporting wire structure of claim 4, wherein said wire lengths are formed of a wire material of approximately 18 gauge, and said wire material is wrapped around the said core when assembled.

6. The supporting wire structure of claim 5, wherein the wire lengths being formed of wire of substantially less than 18 gauge and said wire structure capable of being bent to accommodate and secure the floral arrangements in place during its display.

7. The supporting wire structure of claim 1, wherein the series of wire lengths extend from three sides of the core structure, the core structure having a bottom, without any wires extending therefrom, to allow the floral arrangement as supported to rest upon a flattened surface such as a table or suspended upon a wall.

8. The supporting wire structure of claim 1, wherein the series of wire lengths extend from all sides of the core structure, for holding the floral arrangement secured in place thereto, and the supporting wire structure with its floral arrangement may be suspended vertically during its usage and display.

9. The supporting wire structure of claim 1, wherein said core structure may be formed of a polymer foam, capable of retaining moisture, to enhance the usable life of the floral arrangement when secured onto the wire structure during its assembly and application.
